(19) United States
(12) Patent Application Publication
(10) Pub. No.: US 2002/0112475 A1
(43) Pub. Date: Aug. 22, 2002

(54) Method and apparatus for controlling fluid pressure in a hydraulically-actuated device

(76) Inventor: Michael Cannestra, Kenosha, WI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/068,739

(22) Filed: Feb. 6, 2002

Related U.S. Application Data
(60) Provisional application No. 60/267,025, filed on Feb. 7, 2001.

(51) Int. Cl. F15B 13/16

(52) U.S. Cl. 60/468; 91/361

(57) ABSTRACT

A method and system for controlling fluid pressure in a hydraulically actuated device is provided, in which the device receives an input indicating the amount of work that the device is to perform, and the threshold pressure of a relief valve is adjusted so that the pressure of the fluid is appropriate for the amount of work indicated by the input. In one implementation, the device receives a user input representing the amount of work to be performed by the device. Based on the user input, a setting for a relief valve that is sufficient to maintain the fluid pressure at a level appropriate for the amount of work required is determined. An electrical signal is then sent to the relief valve to adjust it to the determined setting. Determining the proper setting for the relief valve may involve referencing a look-up table that maps user input values to electrical signal values. It may also involve calculating the value of the signal needed to adjust the relief valve to the determined setting, by, for example, inputting the value of the user input into a function and obtaining the signal value as a result.

### CROSS REFERENCE TO RELATED APPLICATIONS

This application claims the benefit of U.S. Provisional Application No. 60/267,025, filed Feb. 7, 2001.

### TECHNICAL FIELD

The invention relates generally to hydraulically actuated devices, and, more particularly, to control systems for keeping hydraulic fluid in a hydraulically actuated device at a pressure that is appropriate to the amount of work that is required by the device.

### BACKGROUND

Many types of machines are hydraulically actuated. That is, they use fluid to transfer force from one point to another to cause work to be performed. Examples of machines that may be hydraulically actuated include backhoes and forklifts. A typical configuration for hydraulically actuated machines is as follows., The fluid is held within a loop or circuit. At one part of the circuit there is a pump that, when active, compresses the fluid, causing the pressure of the fluid to increase. The pump may be driven by a prime mover, such as an engine. A pressure relief valve is also included in the circuit to ensure that the pressure of the fluid does not get too high. The pressure relief valve is typically settable to some threshold level so that, if the threshold level is reached, the valve opens to release fluid and thereby maintain the appropriate pressure. Any excess fluid that is not currently needed within the loop may be stored in a reservoir.

A hydraulically-actuated machine typically has a system of pipes, tubes and valves to channel the fluid to where it is needed to perform the work of the machine. However, the fluid pressure and volume required to perform the work may vary depending on the task the machine is required to perform. For example, a machine might have a hydraulically operated bucket in the front and a hydraulically operated backhoe in the back. More fluid pressure and volume is required if the user of the machine is operating both devices at the same time than if the user is only operating the bucket. But the machine's hydraulic pump may only be capable of pumping the fluid at a fixed rate. Thus, any fluid that is not required to perform work ends up building up within the circuit until it reaches the threshold pressure of the relief valve. After that point, it gets forced out of the circuit through the relief valve, creating excess heat and wasting energy.

Schemes have been developed to address this problem. However, many of them involve the use of a complex network of shuttle valves and compensation valves. Thus, it can be seen that there is a need for a new method and system for controlling fluid pressure in a hydraulically actuated device.

### SUMMARY

In accordance with this need, a method and system for controlling fluid pressure in a hydraulically actuated device is provided, in which the device receives an input indicating the amount of work that the device is to perform, and the threshold pressure of a relief valve is adjusted so that the pressure of the fluid is appropriate for the amount of work indicated by the input.

In one implementation, the device receives a user input to the device representing the amount of work to be performed by the device. Based on the user input, a setting for a relief valve that is sufficient to maintain the fluid pressure at a level appropriate for the amount of work required is determined. An electrical signal is then sent to the relief valve to adjust it to the determined setting. Determining the proper setting for the relief valve may involve referencing a look-up table that maps user input values to electrical signal values. It may also involve calculating the value of the signal needed to adjust the relief valve to the determined setting, by, for example, inputting the value of the user input into a function and obtaining the signal value as a result.

The invention may be implemented as a system for controlling fluid pressure in a device, which has a fluid circuit, a relief valve settable to a threshold pressure, and a means for detecting a user input and setting the threshold pressure of the relief valve to a level sufficient to cause the fluid in the loop to be at a pressure appropriate to transfer a proper amount of force as indicated by the user input. The detecting and setting means is may be a programmed controller electrically coupled to the relief valve.

The invention may also be implemented as a hydraulically actuated apparatus having a user input device, a controller electrically coupled to the user input device, a hydraulic loop containing a fluid, and a relief valve in fluid communication with the hydraulic loop and electrically coupled to the controller. In one aspect, the controller may determine the degree to which a user is manipulating the device and, based on the determined degree, send a signal to the relief valve to cause the relief valve to release fluid from the hydraulic loop, wherein the amount of fluid released is proportional to the determined degree.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings, of which:

FIG. 1 depicts an embodiment of the invention; and

FIG. 2 depicts another embodiment of the invention.

### DETAILED DESCRIPTION OF THE PREFERRED EMBODIMENTS

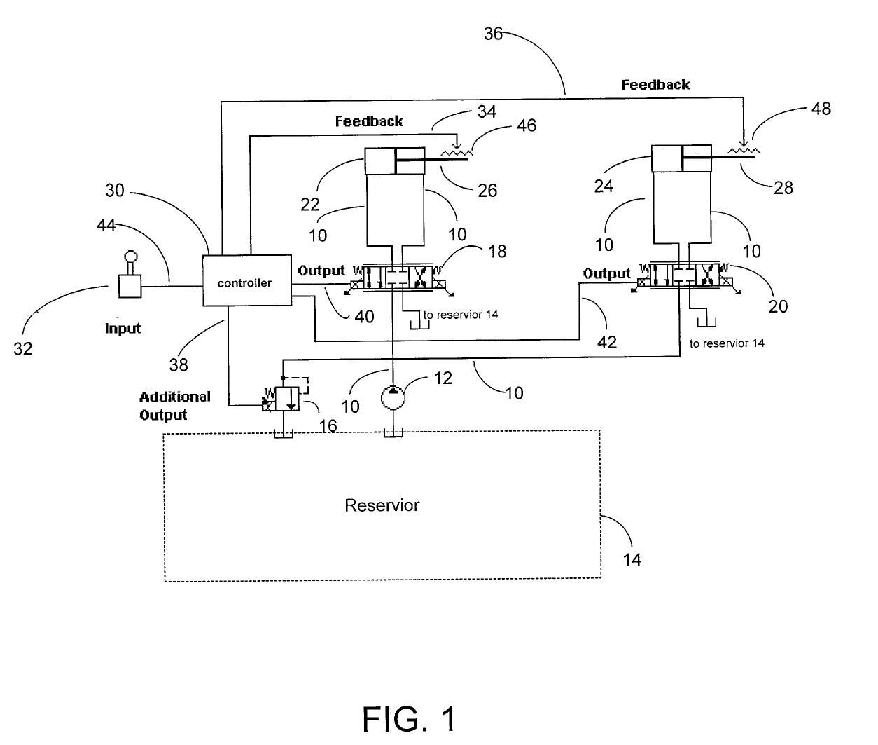

The invention is generally directed to a method and system for controlling fluid pressure in a hydraulically-actuated device, in which a relief valve is adjusted based on input to the device, so that the pressure of the fluid is appropriate for the amount of work required by the device. Referring to FIG. 1 (FIG. 1), an embodiment of the invention includes a hydraulic circuit 10 having a contained therein a fluid. A pump 12 communicates with the circuit 10 to pump the fluid, thereby increasing the pressure and/or the volume of the fluid. A reservoir 14 fluidly communicates with the pump 12 and holds excess fluid, thereby providing overflow storage for the circuit 10 and a source of fluid for the pump 12. A normally closed relief valve 16 communicates with the circuit 10 and the reservoir 14. The relief valve 16 is settable to a threshold pressure. When the fluid pressure in the circuit 10 reaches the threshold pressure, the relief valve 16 opens, thereby permitting fluid to pass from the circuit 10 to the reservoir 14. In one implementation, the relief valve 16 is a variable electrical proportional relief valve. An example of such a valve is TS 10-26 proportional electric relief valve manufactured by HYDRAFORCE INC., of Lincolnshire, Ill.

A first directional valve 18 and a second directional valve 20 are arranged in communication with the circuit 10 and the reservoir 14. A first hydraulic cylinder 22 and a second hydraulic cylinder 24 are also in communication with the circuit 10. The hydraulic cylinders 22 and 24 include respective actuators 26 and 28. The actuators 26 and 28 may be coupled to a variety of types of devices, including lifting and moving devices. Although the actuators are depicted as straight pieces in FIG. 1, it is understood that they represent any type of part that can be moved by a hydraulic cylinder, including gears, screws, and so forth.

The directional valves 18 and 20 may be electrically activated to direct fluid from the circuit 10 to the hydraulic cylinders 22 and 24. Sensors 46 and 48 are disposed near the actuators 26 and 28 respectively and generate signals in proportion to the movement of the actuators 26 and 28 respectively. A controller 30 communicates with the relief valve 16 over a signal path 38, with the directional valves 18 and 20 over signal paths 40 and 42 respectively, and receives feedback from the sensors 46 and 48 over signal paths 34 and 36 respectively. The controller 30 may be implemented in a variety of ways. In one embodiment, it is implemented as a two axis proportional/integrative/derivative (PID) controller, such as an SD1 digital amplifier/controller card manufactured by “Wandfluh AG.” The controller may include a computer-readable medium, such as a memory, having stored therein instructions that the controller executes. An input module 32 communicates with the controller 30 over a signal path 44. The input module 32 is depicted in FIG. 1 as a lever and gearbox that may be manually operated by a user. However, the input module 32 may also be implemented in a variety of well known ways, including a keypad, joystick, etc. It may also be implemented so that it is operated by another machine, thus eliminating the need for an operator. The description will proceed as if there is an operator, however.

During operation, a user selects the direction and speed of the actuators 26 and 28 by manipulating the input module 32. The input module 32 sends signals to the controller 30 representing the user input. The controller 30 calculates the difference between the speed and direction of the actuators 26 and 28 and the speed and direction selected by the operator. The controller 30 operates the directional valves 18 and 20 based on this calculated difference. For example, the controller 30 may send signals via the signal paths 40 and 42 to open the directional valves 18 and 20. The strength of the signals is a function how the controller 30 is programmed. When implemented as a PID controller, the strength of the signal is a function of the PID math.

The controller 30 also sends a signal to the relief valve 16 to set the threshold level of the relief valve 16 to a value that is commensurate to the amount of work the user needs for the machine to perform. For example, if the user requires very little work from the machine, the controller 30 sets the threshold pressure of the relief valve 16 to a low level. Thus, the excess fluid flow—that portion of the fluid that is not needed at the cylinders 22 and 24—could more easily exit the circuit 10 through the relief valve 16.

To determine the appropriate signal to send to the relief valve 16, the controller uses the difference between the speed and direction of the actuators 26 and 28 and the speed and direction selected by the operator. This difference was also used above to operate the directional valves 18 and 20, as described previously. The controller 30 may also add an offset value to the calculated difference to ensure proper flow through the valves The offset value represents the pressure required to push the fluid through the valves and the piping. It is assumed to be a known value that is either supplied by the manufacturer of the valves and piping or obtained by well-known testing techniques. Furthermore, the controller 30 may have a look-up table to correlate user input values with possible values of signals that are to be sent to the relief valve 16 to keep the fluid pressure at a level commensurate with the amount of work required without wasting excessive heat and energy. The controller may also have a look-up table to correlate differences values (i.e. values that represent the difference between the user input and actuator positions) with appropriate values of signals that may be sent to the relief valve 16 for the same purpose. Also, the controller may be programmed with a function that takes a user input value and arrives at the proper signal value. Finally, the controller may be programmed with a function that takes the calculated difference (from above) and arrives at the proper signal value, again for the purpose of keeping the fluid pressure in the circuit at a level commensurate with the amount of work required without wasting excessive heat and energy.

The default threshold value for the relief valve 16 may be set low, and the logic may be set to that the threshold pressure changes in proportion to the strength of the current or signal sent from the controller 30. In critical circuits, such as those used for steering, the relief valve 16 may be set to a high threshold pressure, and the logic reversed so that the threshold pressure of the relief valve 16 changes in reverse proportion to the strength of the signal or current from the controller 30. Of course, the communication between the controller 30 and the relief valve 16 may also be digital, so that the information as to the how much and in which direction the threshold setting of the relief valve 16 is to change is placed in a bit stream.

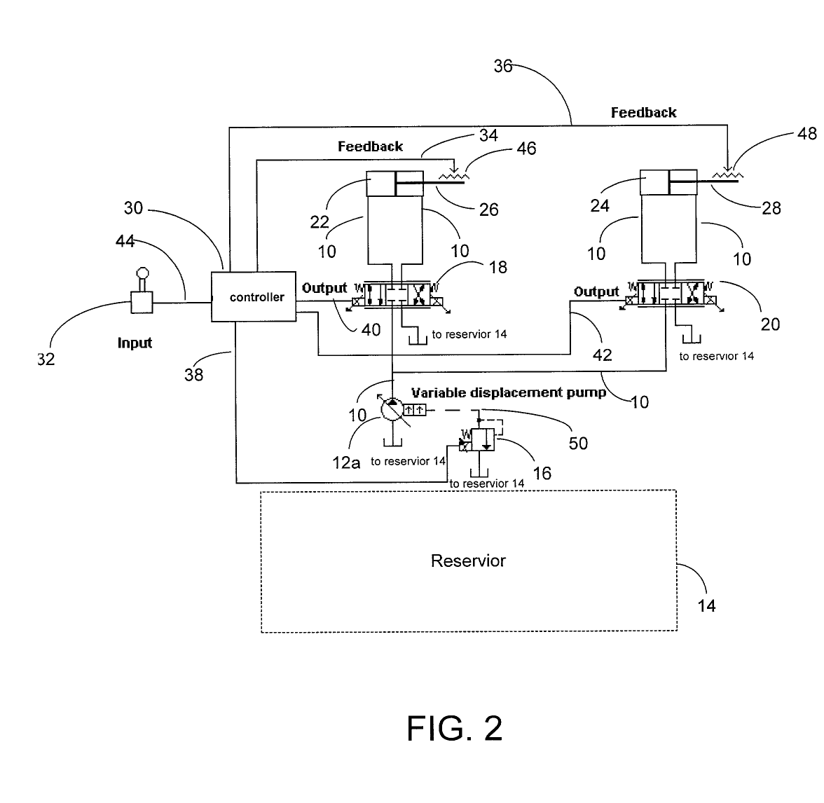

Referring to FIG. 2, another embodiment of the invention will now be described. In this embodiment, the pump 12 of FIG. 1 is replaced by a variable displacement pump 12a. The variable displacement pump 12a has at least two outlet ports - a main outlet port that communicates with the circuit 10 and an auxiliary outlet port that communicates with the relief valve 16 via a hydraulic line 50. Although shown as separate components, the relief valve 16 may be integrated into the displacement pump 12a as a single component. When the pressure at the auxiliary outlet port increases, the variable displacement pump 12a reacts by increasing its output. Conversely, when pressure at the auxiliary outlet port of the variable displacement pump 12a decreases, the variable displacement pump 12a reacts by decreasing its output.

The embodiment shown in FIG. 2 enables the controller 30 to adjust the output of the variable displacement pump 12a through its control of the relief valve 16. For example, if the user requires more work from the hydraulically-actuated device, the controller 30 sends a signal to the relief valve 16 to increase the threshold pressure of the relief valve 16. As a result, the pressure at the auxiliary outlet of the variable displacement pump 12a increases, thereby causing the variable displacement pump 12a to increase its output accordingly. The embodiment of FIG. 2 thus allows the work performed by the pump to more closely match the work required by the actuators.

It can thus be seen that a new a useful method and system for controlling pressure in a hydraulically actuated device has been provided. In view of the many possible embodiments to which the principles of this invention may be applied, it should be recognized that the embodiments described herein with respect to the drawing figures is meant to be illustrative only and should not be taken as limiting the scope of invention. For example, those of skill in the art will recognize that the elements of the illustrated embodiments may modified in arrangement and detail without departing from the spirit of the invention. Therefore, the invention as described herein contemplates all such embodiments as may come within the scope of the following claims and equivalents thereof.

What is claimed is:

1. A method for controlling fluid pressure in a hydraulically-actuated device, the device having a relief valve for allowing fluid to escape upon reaching a threshold pressure, the method comprising:
receiving an input to the device, wherein the input indicates the amount of work that the device is to perform; and,
adjusting the threshold pressure of the relief valve so that the pressure of the fluid is appropriate for the amount of work indicated by the input.

2. A computer-readable medium having stored thereon computer-executable instructions for performing the method of claim 1.

3. The method of claim 1, wherein the hydraulically-actuated device includes an actuator, and wherein the amount of work indicated by the input is indicated in terms of the displacement required by the actuator, the method further comprising:
receiving a signal from a sensor indicating the displacement of the actuator; and
calculating the difference between the displacement of the actuator and the displacement required by the actuator,
wherein the adjusting step comprises adjusting the threshold pressure of the relief valve so that the pressure of the fluid is sufficient to move the actuator so as to reduce difference between the displacement of the actuator and the displacement required by the actuator.

4. A method for controlling fluid pressure in a hydraulically-actuated device, the device having an electrically adjustable relief valve, the method comprising:
receiving a user input to the device, wherein the input represents the amount of work to be performed by the device;
determining, based on the user input, a setting for the relief valve to maintain the fluid pressure at a level appropriate for the amount of work required; and
sending an electrical signal to the relief valve to adjust the relief valve to the determined setting.

5. A computer-readable medium having stored thereon computer-executable instructions for performing the method of claim 4.

6. The method of claim 4, wherein the hydraulically-actuated device includes an actuator, and wherein the amount of work represented by the user input is indicated in terms of a desired speed and direction of the actuator, the method further comprising:
receiving a signal from a sensor indicating the current speed and direction of the actuator; and
calculating the difference between the current speed and direction of the actuator and the desired speed and direction of the actuator,
wherein the sending step comprises sending an electrical signal to the relief valve to adjust the threshold pressure of the relief valve so that the pressure of the fluid is sufficient to cause the actuator to move closer to the desired speed and direction.

7. The method of claim 4, wherein the determining step comprises referencing a look-up table that maps user input values to electrical signal values to determine the value of the signal needed to adjust the relief valve to the determined setting.

8. The method of claim 4, wherein the determining step comprises calculating the value of the signal needed to adjust the relief valve to the determined setting.

9. The method of claim 8, wherein the calculating step comprises inputting the value of the user input into a function and obtaining the signal value as a result.

10. A system for controlling fluid pressure in a device, the system comprising:
a fluid circuit comprising a fluid for transferring force;
a relief valve settable to a threshold pressure, wherein the relief valve allows at least a portion of the fluid to escape from the circuit once the fluid reaches the threshold pressure; and,
a means for detecting a user input and setting the threshold pressure of the relief valve to a level sufficient to cause the fluid in the loop to be at a pressure appropriate to transfer a proper amount of force as indicated by the user input.

11. The system of claim 10, wherein the detecting and setting means comprises a programmed controller electrically coupled to the relief valve.

12. The system of claim 10, wherein the detecting and setting means comprises at least one sensor that senses the displacement of an actuator that is actuated by a force transferred by the fluid.

13. A hydraulically actuated apparatus comprising:
a user input device;
a controller electrically coupled to the user input device;
a hydraulic loop containing a fluid; and,
a relief valve in fluid communication with the hydraulic loop and electrically coupled to the controller,
wherein the controller determines the degree to which a user is manipulating the device and, based on the determined degree, sends a signal to the relief valve to cause the relief valve to release fluid from the hydraulic loop, wherein the amount of fluid released is proportional to the determined degree.

14. The apparatus of claim 13, further comprising a variable displacement pump in fluidic communication with the relief valve and with the hydraulic loop, wherein when the relief valve causes pressure to change in the hydraulic loop, the variable displacement pump reacts by either increasing or decreasing its output to the hydraulic loop.

15. The apparatus of claim 13, further comprising:
at least one actuator for exerting force against a load; and
a sensor for sensing the speed and direction of the actuator and transmitting a signal representing the sensed speed and direction to the controller,
wherein the controller calculates:
the speed and direction that the user wishes the actuator to move based on the degree to which the user is determined to be manipulating the user input device,
the difference between the sensed speed and direction and the speed and direction that the user wishes the actuator to move,
and wherein the signal sent to the relief valve is based on the calculated difference.

16. The apparatus of claim 14, further comprising:
at least one actuator for exerting force against a load; and
a sensor for sensing the speed and direction of the actuator and transmitting a signal representing the sensed speed and direction to the controller,
wherein the controller calculates:
the speed and direction that the user wishes the actuator to move based on the degree to which the user is determined to be manipulating the user input device,
the difference between the sensed speed and direction and the speed and direction that the user wishes the actuator to move,
and wherein the signal sent to the relief valve is based on the calculated difference.

17. An apparatus comprising:
a user input module for receiving a user input representing a desired speed and direction;
a controller electrically coupled to the user input module;
a hydraulic fluid circuit containing a hydraulic fluid;
a reservoir for holding excess hydraulic fluid from the hydraulic fluid circuit;
a pump in fluidic communication with the hydraulic circuit and the reservoir, wherein the pump pumps fluid from the reservoir into the hydraulic circuit;
a hydraulic cylinder having an actuator for exerting force against a load, the hydraulic cylinder being in fluidic communication with the hydraulic fluid circuit;
a directional valve electrically coupled to the controller, the directional valve being located along the hydraulic circuit between the pump and the hydraulic cylinder, the directional valve regulating the flow of hydraulic fluid to the hydraulic cylinder in accordance with signals from the controller;
a relief valve electrically coupled to the controller, the relief valve being in fluidic communication with the hydraulic circuit and the reservoir, the relief valve having a threshold pressure, wherein when the hydraulic fluid in the hydraulic circuit exceeds the threshold pressure, the relief valve permits hydraulic fluid from the hydraulic circuit to pass through it and to enter the reservoir, the threshold pressure being set in accordance with signals received from the controller; and
a sensor electrically coupled to the controller, wherein the sensor senses the displacement of the actuator and transmits signals representing the sensed displacement to the controller.

18. The apparatus of claim 17, wherein the signals representing the displacement of the actuator include data regarding the speed and direction of the actuator.

19. The apparatus of claim 17, wherein the pump is a variable displacement pump, and is in fluidic communication with the relief valve and with the hydraulic loop, wherein when the relief valve causes pressure to change in the hydraulic loop, the variable displacement pump reacts by either increasing or decreasing its output to the hydraulic loop.

20. The apparatus of claim 17, wherein the controller:
receives a signal from the sensor indicating the current speed and direction of the actuator;
calculates the difference between the current speed and direction of the actuator and the desired speed and direction of the actuator; and
adjusts the threshold pressure of the relief valve so that the pressure of the hydraulic fluid is sufficient to cause the hydraulic cylinder to move the actuator so that it approaches the desired speed and direction.
